(19) United States
(12) Patent Application Publication
(10) Pub. No.: US 2006/0039461 A1
(43) Pub. Date: Feb. 23, 2006

(54) Video coding method

(75) Inventor: Gerhard Engelmann, Vienna (AU)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/527,774

(22) PCT Filed: Aug. 29, 2003
(86) PCT No.: PCT/IB03/03955

§ 371 Date: Mar. 14, 2005

(30) Foreign Application Priority Data
Sep. 17, 2002 (EP) 02102367.6

(51) Int. Cl. H04N 11/04; H04N 11/02; H04N 7/12; H04B 1/66

(52) U.S. Cl. 375/240.01

(57) ABSTRACT

In a coding method and coding system to generate a compressed data stream (CAV) with a variable bit rate from digital audio and/or video signals, with a prescribed limitation on the overall bit quantity/rate of the data stream, the signals are written to segments (s1, s2) of a temporary buffer (3) and analyzed as to the complexity of the signals in an analysis means (4). With the complexity information (C-INF) thereby obtained, the audio and/or video signals read from the temporary buffer (3) segment by segment are converted in a compression means (5) into the compressed data stream (CAV) with a variable bit rate, wherein the bit rate of the generated data stream is distributed within the segment as a function of the complexity information and of a segment-overall-bit-quantity provided for the segment in question. The data stream (CAV) may be stored in a memory means (6) or transmitted via a data transmission means (7).

The invention relates to a coding method of generating a compressed data stream with variable bit rate from digital audio and/or video signals or from audio and/or video signals digitized from analog signals, wherein the overall bit quantity of the data stream does not exceed a prescribed limit.

The invention further relates to a coding system for generating a compressed data stream with variable bit rate from digital audio and/or video signals or from analog audio and/or video signals digitized by an analog/digital converter, wherein the overall bit quantity of the data stream does not exceed a prescribed limit.

The invention further relates to a computer program product that can be loaded into the internal memory of a digital computer, and which comprises sections of software code, to implement the coding method to generate a compressed data stream with variable bit rate from audio and/or video signals, wherein the overall bit quantity of the data stream does not exceed a prescribed limit.

A coding method of this kind and a coding system of this kind are known from document GB 2 349 025 A, wherein, in a first step, prestored video material is subjected in its entirety to a compression which delivers a first coded bit stream, the overall bit quantity of which lies significantly above the prescribed limit. In a second step, a single or repeated re-coding of the first bit stream takes place in order to generate from it a second bit stream with variable bit rate having an overall bit quantity below the prescribed limit. This method is provided for application in DVD authoring.

It is a general principle that, in the storage or transmission of audio-video material, signal compression methods such as MPEG frequently have to be used in order that the audio/video material can be recorded on storage media with a limited memory capacity or transmitted via transmission channels with restricted bandwidth. On the other hand, signal compression is usually associated with information losses which are all the greater the more strongly the signal is compressed. Signals can be compressed in such a way that a data stream with a constant bit rate is obtained as a result, which means that a certain recording time can be guaranteed for a given memory capacity of the recording medium. Since, however, the complexity of audio and video sequences varies in terms of time, this ultimately means that memory capacity is wasted in the case of simple sequences, whilst quality losses have to be accepted in the case of more complex sequences. In practice, therefore, an appropriately high bit rate has to be set (at the expense of the possible recording duration) in order to achieve a good quality of the resultant signals even in cases of the highest complexity.

On the other hand, with modem compression methods such as MPEG, the compression depth and thereby the resultant bit rate of the generated data stream can be dynamically altered, making it possible to select the bit rate during the recording according to the instantaneous complexity of the signals to be compressed, wherein it must simultaneously still be guaranteed that the mean data rate does not exceed a prescribed limit in order that the intended recording duration on a storage medium can be adhered to. With audio or video recordings with many complex sequences, this can, however, lead to the quality of the recorded data stream becoming ever poorer since it is not known during the recording how complex the following video sequences will be.

In order to overcome this problem of reduced quality towards the end of the audio or video recording, in professional applications, as described in the cited document GB 2 349 025 A with reference to DVD authoring, the entire—uncompressed—prestored video material is analyzed in a first operation in order to establish what bit rate requirement exists for the individual video sequences, in order to achieve a recording quality that is as uniformly high as possible. Only in a second operation, or in operations repeated multiple times, does the final coding of the material take place in accordance with the results of the preceding analysis.

With the known coding method and the known coding system, the disadvantage has emerged that the storage and compression or processing of the audio or video material in real-time is not possible. Although this is acceptable in professional applications, in which a high-quality storage result is the main consideration as compared with the time needed to achieve it, it is unreasonable to expect a private user to have to spend considerable additional time, after the actual recording time, for the analysis and final storage of his audio or video recordings.

It is the object of the invention to create a coding method in accordance with the generic type specified in the first paragraph, a coding system in accordance with the generic type specified in the second paragraph and a computer program product in accordance with the generic type specified in the third paragraph, wherein the above-mentioned disadvantages are avoided. To achieve the above-mentioned object, in a coding method of this kind, the following further steps are provided:

the audio and/or video signals are put into intermediate storage in a temporary buffer,

the audio and/or video signals are analyzed in respect of the complexity of the signal waveform in order to obtain complexity information,

the audio and/or video signals put into intermediate storage in the temporary buffer are divided into individual segments,

the audio and/or video signals are read, segment by segment, from the temporary buffer and, with the complexity information assigned to them, are subjected to a compression method for signal compression which ultimately delivers a data stream with a variable bit rate, wherein the bit rate is distributed within the segment as a function of the complexity information and of a segment-overall-bit-quantity provided for the segment in question, and

the data stream is stored in a memory means or transmitted via a data transmission device.

To achieve the above-mentioned object, in a coding system of this kind, the following are further provided:

a temporary buffer to which the audio and/or video signals can be written,

an analysis means for analyzing the audio and/or video signals in respect of the complexity of their waveforms, wherein complexity information can be generated,

a control means for dividing the audio and/or video signals stored in the temporary buffer into individual segments,

a compression means for converting the audio and/or video signals into a compressed data stream with a variable bit rate, wherein the audio and/or video signals can be read, segment by segment, from the temporary buffer and sent, with the complexity information assigned to them, to the compression means, wherein the compression means can be controlled in such a way that the bit rate of the generated data stream is distributed within the segment as a function of the complexity information and of a segment-overall-bit-quantity provided for the segment in question, and

a memory means or data transmission means for storing or transmitting the data stream.

Due to the features in accordance with the invention, a higher recording quality is achieved without a waiting time perceptible to the user arising for the analysis of the audio and/or video signals. In reality, the method in accordance with the invention can be implemented in real-time and the system in accordance with the invention can be operated in real-time since only a small time displacement occurs before the first segment of the temporary buffer is written with the audio and/or video signals, from which time the analysis and compression of the signals can take place in real-time. If a hard disk is used as the memory medium, the additional time displacement arising as a result of write access lies in the order of milliseconds and can therefore be ignored. As compared with conventional methods, for which the implementation time requires two complete operations of the audio or video material to be processed before complete compression is achieved, the additional time required is thereby limited to the duration of writing one segment.

Furthermore, as a result of the features in accordance with the invention, the risk no longer exists that the quality of the resultant data stream will drop towards the end of recording or transmission if the underlying audio or video sequences are very complex.

In accordance with the measures as claimed in claims 2 and 10, the advantage is obtained that the segment partitioning of the temporary buffer can be dealt with very flexibly.

In accordance with the measures as claimed in claims 3 and 11, the advantage is obtained that access conflicts between the independent memory areas or memory units of the temporary buffer can be avoided. Whilst, for example, the audio and/or video signals are being written to a first memory area, signals can be simultaneously read from a second memory area, analyzed and compressed if necessary. Once a segment has been processed, switching takes place between the two memory areas.

An embodiment of the invention that is technically simple to realize is obtained when the audio and/or video signals stored in the temporary buffer are divided into segments of equal length. More complex to implement but more advantageous in respect of achievable quality is an embodiment of the invention in which the lengths of the segments of the audio and/or video information stored in the temporary buffer can be altered in an adaptive manner as a function of the signal complexity. This means that if the analysis reveals that high complexity sequences are present in a segment, the subsequent sequences are shortened in terms of time, or the segment-overall-bit-quantity assigned to them is increased in the expectation that further complex sequences will occur.

In accordance with the measures as claimed in claims 6 and 13, the advantage is obtained that the audio and/or video signals are precompressed relatively weakly, i.e. are prestored in a high quality, which simplifies their subsequent final compression and, above all, enables a reduction in the size of the temporary buffer. In an especially advantageous embodiment of the invention, simultaneously with their precompression, the audio and/or video signals are analyzed as to the complexity of their signal waveforms and the complexity information thus obtained is stored together with the audio and/or video signals in the temporary buffer for further use in the subsequent compression procedure. The complexity information thereby obtained may comprise, for example, motion vectors obtained from an MPEG compression.

In accordance with the measures as claimed in claim 8, during the coding process, a reserve of bit quantity can be achieved for the coding of the subsequent segments.

In accordance with the measures as claimed in claim 14, program processes running in parallel and independently of one another can ensure maximum operational reliability and stability of the coding system in accordance with the invention.

In accordance with the measures as claimed in claim 15, a computer program product that can be loaded directly into the internal memory of a digital computer and which comprises sections of software code is provided, wherein the steps of the coding method in accordance with the invention are implemented with the computer when the product is running on the computer.

Further features and advantages of the invention are explained below.

The invention will be further described with reference to examples of embodiments shown in the drawings, to which, however, the invention is not restricted.

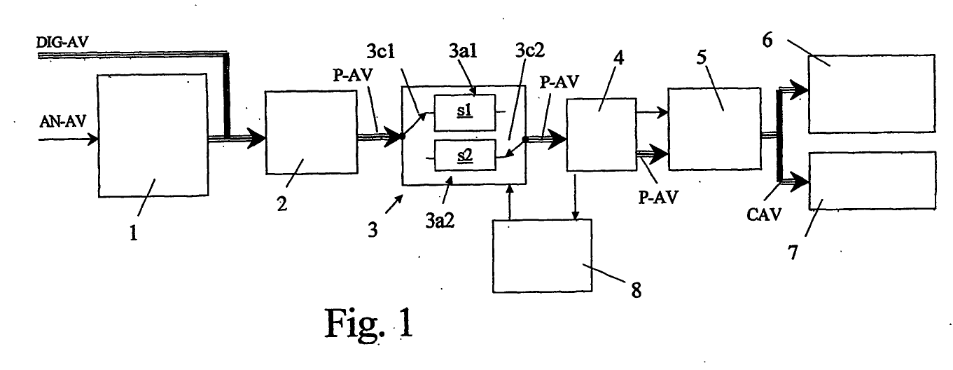

FIG. 1 shows a first embodiment of a coding system in accordance with the invention in a block diagram.

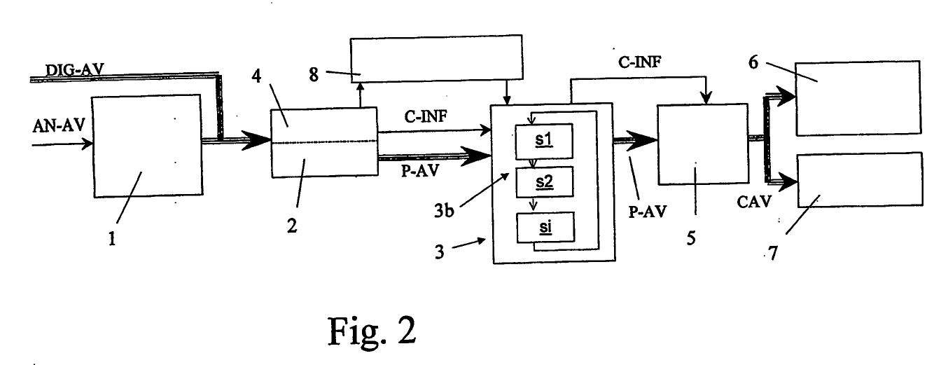

FIG. 2 shows a second embodiment of a coding system in accordance with the invention in a block diagram.

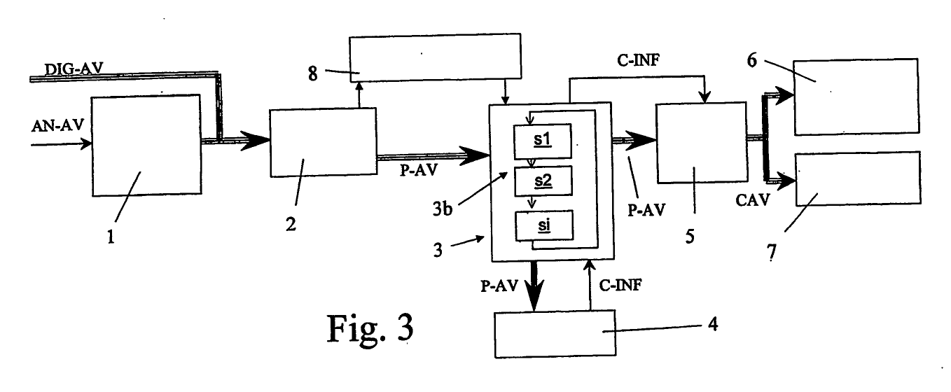

FIG. 3 shows a variant of the second embodiment of a coding system in accordance with the invention in a block diagram.

FIG. 1 shows, schematically in a block diagram, a coding system in accordance with the invention. The coding system comprises initially an input stage with an analog/digital converter 1, which converts incoming analog audio and/or video signals AN-AV into digital signals, and transmits them to a precompression means 2. Digital audio and/or video signals DIG-AV can be processed directly by being sent, without preparation, to the input of the precompression means 2. Precompression means 2 is provided as an option in order to precompress slightly the incoming audio and/or video signals so that, as a result, the data flow rate in the system and the capacity of memory units required is reduced. The precompression means 2 may comprise, for example, an integrated circuit for MPEG compression. The signals may, however, also be fed through uncompressed by precompression means 2.

From precompression means 2, the uncompressed or slightly precompressed audio and/or video signals P-AV pass to the input of a temporary buffer 3, where they are written to the memory under the control of a control means 8. The temporary buffer 3 may comprise a magnetic disk drive, such as a hard disk, or a semiconductor memory, such as RAM modules. In the present case, the temporary buffer 3 comprises two semiconductor memory areas 3a1 and 3a2, which may also take the form of separate units. Changeover switches 3c1 and 3c2 ensure that a changeover between the two memory areas can take place during the writing and reading of data, so that the precompressed audio and/or video signals P-AV can, for example, be written to memory area 3a1, whilst, simultaneously, data that was stored earlier is read from memory area 3a2 for a subsequent analysis. On completion of the write and read procedure, a switchover between the memory areas takes place, as a result of which access conflicts can be excluded. The writing and reading hereby takes place in segments, wherein the size of a memory area defines the maximum size of a particular segment s1, s2.

Control means 8 is responsible for the division of the audio and/or video signals to be written to the temporary buffer into individual segments s1, s2, wherein fixed segment lengths or an adaptive adjustment of the segment lengths to match the particular signal complexity are possible.

The audio and/or video signals read from segment s2 of temporary memory 3 are sent to an analysis means 4, where they are analyzed in respect of the complexity of their waveform and the information thereby obtained is then used as complexity information C-INF for final compression of the audio and/or video signals.

This final compression of the audio and/or video signals takes place in a compression means 5 in which the read-in audio and/or video signals are converted segment by segment into a data stream CAV with a variable bit rate, wherein the bit rate of the generated data stream is distributed within the segment as a function of the complexity information C-INF and of an overall bit quantity provided for the particular segment, in order to obtain a uniformly high quality of the resultant signal. In all cases, the overall bit quantity/rate of the resultant data stream CAV remains below the prescribed limit, which depends on the nature of memory means 6 or transmission means 7 in which the data stream CAV is stored or via which it is transmitted. The memory means used are magnetic, magneto-optical or optical storage media, such as hard disks, DVD+R(W), DVD-R(W) etc. Compression means 5 may operate in accordance with MPEG2 or MPEG4 Standard, for example.

The coding system presented may, for example, be realized as a software product stored on a storage medium (diskette, CD-ROM, hard disk), loaded into the internal memory of a conventional personal computer equipped with appropriate interface cards for processing and storing audio and/or video signals. It is also possible for the entire coding system to be provided as a highly-integrated semiconductor chip, known as a CODEC, which can be installed in DVD recorders etc. Both with the version of the coding system in a PC and with the version as a CODEC, the system is internally computer-program controlled, wherein multiple computer processes (tasks) are in progress and a first program process controls the processing of the audio and/or video signals up to and including their storage in the temporary buffer, and a second program process, running in parallel, controls the processing of the audio and/or video signals from their reading, segment by segment, out of the temporary buffer until the resultant data stream is stored or transmitted.

FIG. 2 shows, schematically in a block diagram, a further coding system in accordance with the invention. Like the first embodiment, this second embodiment comprises an input stage with an analog/digital converter 1 for converting incoming analog audio and/or video signals AN-AV into digital signals in order to transmit them to a precompression means 2. Digital audio and/or video signals DIG-AV are sent directly to precompression means 2. By contrast with the embodiment in FIG. 1, however, precompression means 2 operates directly with analysis means 4, so taking place simultaneously with the precompression of the audio and/or video signals is the analysis of these signals regarding their complexity, and the resultant complexity information C-INF is stored in temporary buffer 3, together with the precompressed audio and/or video signals P-AV, under the control of control means 8, wherein control means 8 uses information from analysis means 4 for segmenting temporary buffer 3.

Buffer 3 is hereby designed as a ring buffer 3b, which has a multiplicity of segments s1, s2 . . . si, the size of which can be controlled by control means 8. Writing to and reading from the segments s1, s2 to si takes place in sequence, wherein, after segment si, segment s1 is again addressed.

The remaining design of the coding system shown in FIG. 2 corresponds with that shown in FIG. 1. Together with the complexity information C-INF, the precompressed audio and/or video signals P-AV are read, segment by segment, from buffer 3 and sent to a compression means 5, where a conversion to a data stream CAV with a variable bit rate takes place, wherein the bit rate of the generated data stream CAV is distributed within the segment as a function of the complexity information C-INF and of an overall bit quantity provided for the segment in question, in order to obtain a uniformly high quality of the resultant signal.

Data stream CAV is then stored in a memory means 6 or transmitted via transmission means 7. Like the first embodiment, this embodiment too may be realized in, for example, a conventional personal computer or as hardware Codec, and may have appropriate computer program control.

FIG. 3 shows, schematically as a block diagram, a variant of the embodiment of the coding system in accordance with the invention as shown in FIG. 2. This third embodiment differs from the second in that the precompression means 2 does not operate directly with analysis means 4, but is separated from it. The audio and/or video signals P-AV issued from precompression means 2 are written to temporary buffer 3 and also directed to analysis means 4 where they are analyzed, and the resultant complexity information C-INF is added to the precompressed audio and/or video signals P-AV in temporary buffer 3 for further use. In this embodiment, the signal analysis therefore takes place during the intermediate storage of the audio and/or video signals P-AV. A computer program control for this embodiment could comprise three processes, wherein a first process is responsible for the signal processing until the audio and/or video signals are written to temporary buffer 3, a second process is responsible for the analysis, and a third process reads the stored audio and/or video signals and the complexity information C-INF from temporary buffer 3 and is responsible for the final compression of the audio and/or video signals into CAV signals.

The remaining components of the embodiment of the compression system as shown in FIG. 3 correspond to those shown in FIG. 2. For an explanation of these, therefore, reference is made to the above description.

1. A coding method of generating a compressed data stream with variable bit rate from digital audio and/or video signals (DIG-AV) or from audio and/or video signals (P-AV) digitized from analog signals (AN-AV), wherein the overall bit quantity/rate of the data stream does not exceed a prescribed limit, characterized in that:
the audio and/or video signals (P-AV) are put into intermediate storage in a temporary buffer (3),
the audio and/or video signals are analyzed in respect of the complexity of the signal waveform in order to obtain complexity information (C-INF),
the audio and/or video signals put into intermediate storage in the temporary buffer (3) are divided into individual segments (s1, s2 . . . si),
the audio and/or video signals (P-AV) are read, segment by segment, from the temporary buffer (3) and, with the complexity information (C-INF) assigned to them, are subjected to a compression method for signal compression which ultimately delivers a data stream (CAV) with a variable bit rate, wherein the bit rate is distributed within the segment as a function of the complexity information and of a segment-overall-bit-quantity provided for the segment in question, and
the data stream is stored in a memory means (6) or transmitted via a data transmission device (7).

2. A coding method as claimed in claim 1, characterized in that the temporary buffer (3) is organized as a ring buffer (3b).

3. A coding method as claimed in claim 1, characterized in that the temporary buffer (3) comprises at least two independent memory areas (3a1, 3a2) or memory units, to which or from which audio and/or video signals (P-AV) can be written or read alternately, segment by segment.

4. A coding method as claimed in claim 1, characterized in that the audio and/or video signals stored in temporary buffer (3) are divided into segments of equal length.

5. A coding method as claimed in claim 1, characterized in that the lengths of the segments of the audio and/or video information stored in temporary buffer (3) can be altered adaptively as a function of the signal complexity.

6. A coding method as claimed in claim 1, characterized in that the audio and/or video signals are subjected to precompression before they are stored in temporary buffer (3).

7. A coding method as claimed in claim 6, characterized in that, during the precompression, the audio and/or video signals are analyzed in respect of the complexity of their signal waveforms, and the complexity information (C-INF) thereby obtained is stored, together with the audio and/or video signals (P-AV) in temporary buffer (3) for further use in the subsequent compression procedure.

8. A coding method as claimed in claim 1, characterized in that, in the event that the segment-overall-bit-quantity provided for a segment is not fully used up owing to the low complexity of the signals, the remainder is assigned to the subsequent segments.

9. A coding system for generating a compressed data stream with variable bit rate from digital audio and/or video signals (DIG-AV) or from analog (AN-AV) audio and/or video signals digitized by an analog/digital converter, wherein the overall bit quantity/rate of the data stream does not exceed a prescribed limit, characterized by:
a temporary buffer (3) to which the audio and/or video signals (P-AV) can be written,
an analysis means (4) for analyzing the audio and/or video signals in respect of the complexity of their waveforms, wherein complexity information (C-INF) can be generated,
a control means (8) for dividing the audio and/or video signals stored in the temporary buffer (3) into individual segments (s1, s2 . . . si),
a compression means (5) for converting the audio and/or video signals into a compressed data stream (CAV) with a variable bit rate, wherein the audio and/or video signals can be read, segment by segment, from the temporary buffer (3) and sent, with the complexity information (C-INF) assigned to them, to the compression means (5), wherein the compression means can be controlled in such a way that the bit rate of the generated data stream (CAV) is distributed within the segment as a function of the complexity information and of a segment-overall-bit-quantity provided for the segment in question, and
a memory means (6) or data transmission means (7) for storing or transmitting the data stream.

10. A coding system as claimed in claim 9, characterized in that the temporary buffer (3) is organized as a ring buffer (3b).

11. A coding system as claimed in claim 9, characterized in that the temporary buffer (3) comprises at least two independent memory areas (3a1, 3a2) or memory units, to which or from which audio and/or video signals can be written or read alternately, segment by segment.

12. A coding system as claimed in claim 9, characterized in that the lengths of the segments of the audio and/or video information stored in the temporary buffer can be adapted by the control means (8) as a function of the signal complexity.

13. A coding system as claimed in claim 9, characterized by a precompression means (2) for precompressing the audio and/or video signals before they are stored in the temporary buffer.

14. A coding system as claimed in claim 9, characterized in that it can be operated by means of computer program control, wherein a first program process controls the processing of the audio and/or video signals up to and including their storage in the temporary buffer, and a second program process, running simultaneously, controls the processing of the audio and/or video signals from their reading, segment by segment, out of the temporary buffer until the resultant data stream is stored or transmitted.

15. A computer program product that can be loaded directly into the internal memory of a digital computer and which comprises sections of software code, wherein the steps of the coding method as claimed in claim 1 are implemented with the computer when the product is running on the computer.

16. A computer program product as claimed in claim 15, wherein the computer program product is stored on a computer-readable medium.
